(19) United States
(12) Patent Application Publication
(10) Pub. No.: US 2022/0094677 A1
(43) Pub. Date: Mar. 24, 2022

(54) INFORMATION RIGHTS MANAGEMENT DOCUMENT SHARE

(71) Applicant: Hewlett-Packard Development Company, L.P., Spring, TX (US)

(72) Inventors: Gaurav Roy, Spring, TX (US); Rebecca Ann Norlander, Seattle, WA (US); Rachelle Daniel, Palo Alto, CA (US); Vishal Sharma, Pune (IN)

(21) Appl. No.: 17/468,983

(22) Filed: Sep. 8, 2021

(30) Foreign Application Priority Data
Sep. 23, 2020 (IN) 202041041255

(51) Int. Cl. H04L 29/06

(52) U.S. Cl. CPC H04L 63/08; H04L 65/4015; H04L 65/1069; H04L 65/403

(57) ABSTRACT

In an example implementation according to aspects of the present disclosure, a system, method, and storage medium comprising a processor, memory, and instructions to connect an online conference. The system receives an information rights management document. The system validates each of a set of users against an IRM system corresponding to the IRM document. The system, responsive to validation failure, signals a device driver to block sharing of the IRM document within the online conference.

### BACKGROUND

Online video conferences allow users to virtually meet and communicate both visually and audibly. Online video conferences may allow users to display digital documents within the conference.

### BRIEF DESCRIPTION OF THE DRAWINGS

FIG. 1 illustrates an information rights management document sharing system, according to an example;

FIG. 2 is a block diagram showing an information rights management document sharing system, according to an example;

FIG. 3 is a flow diagram sharing a document based on an information rights management system, according to an example; and

FIG. 4 is a computing device for supporting instructions for an information rights management system, according to an example.

### DETAILED DESCRIPTION

Online video conferences allow many users to congregate in a virtualized environment, whereby all of the users may be in physically distant locations yet are able to communicate in real time with the other users. Video and audio streams transmitted from each of the user's corresponding computing devices to each of receiving user's computing devices. In another implementations, the transmitted video and audio streams may be transmitted to a server where the streams may be multiplexed into a single video and audio stream which includes all of the users' video and audio. Simply stated the video stream corresponds to one or more video feeds within an online conference. For purposes of this disclosures, users and participants may be used interchangeably, and may correspond to an individual who has connected electronically to an online video conference through a computing device.

Online video conferences also may allow users to share their computing device desktops. The sharing allows participating users to see and experience the presenter's actions and activities as if the presenter were physically nearby. Additionally, a presenter may share a document during the online video conference. The document may include confidential information or may be managed by an information management rights (IRM) system. In online video conferences with large numbers of participants, a nefarious user may photograph, or screen capture a confidential document when it is shared. Described herein is an information management rights document sharing system.

In one implementation, a system may support information rights management document sharing. The system may include a processor, memory and instructions to present in an online conference. The system may connect to an online conference, receive an information rights management document, validate that participants of the online conference may view the document, and responsive to validation failure, signal a device driver to obfuscate the shared IRM document.

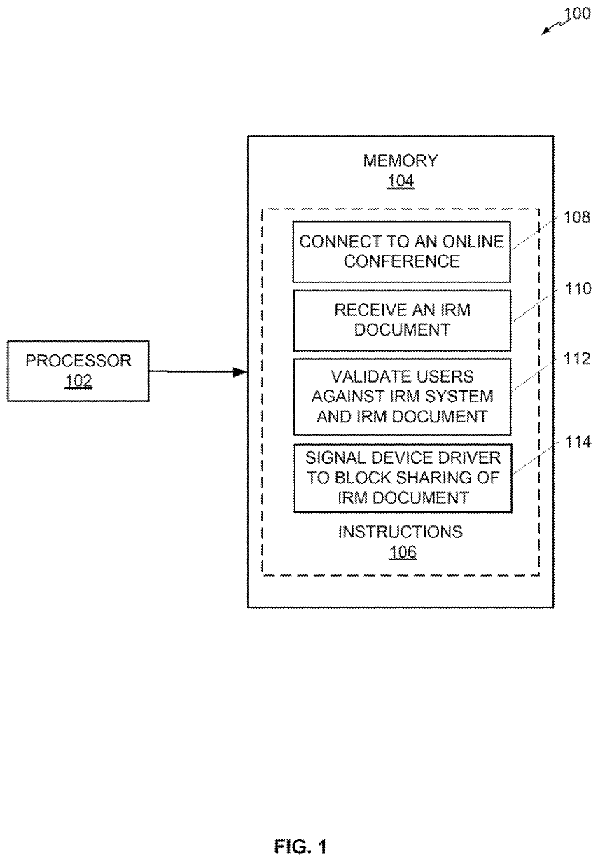

FIG. 1 illustrates an information rights management document sharing system, according to an example. The system 100 may include a processor 102, a memory 104, and instructions 106.

The processor 102 of the system 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may actually be executed on hardware circuitry; however, the hardware circuitry is not dedicated. The hardware circuitry may be in a shared environment where utilization is time sliced. In some implementations the virtualized logical processor includes a software layer between any executing application and the hardware circuitry to handle any abstraction which also monitors and save the application state. Virtual machines (VMs) may be implementations of virtualized logical processors.

A memory 104 may be implemented in the system 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic ram (DRAM) or other hardware implementations for storing processor instructions. Additionally, the virtualized logical memory may be implemented in a software abstraction which allows the instructions 106 to be executed on a virtualized logical processor, independent of any dedicated hardware implementation.

The system 100 may also include instructions 106. The instructions 106 may be implemented in a platform specific language that the processor 102 may decode and execute. The instructions 106 may be stored in the memory 104 during execution. The instructions 106 may be encoded to perform operations such as connect an online conference 108, receive an information rights management (IRM) document 110, validate each of a set of users against an IRM system corresponding to the IRM document 112, and responsive to validation failure, signal a device driver to block sharing of the IRM document within the online conference 114.

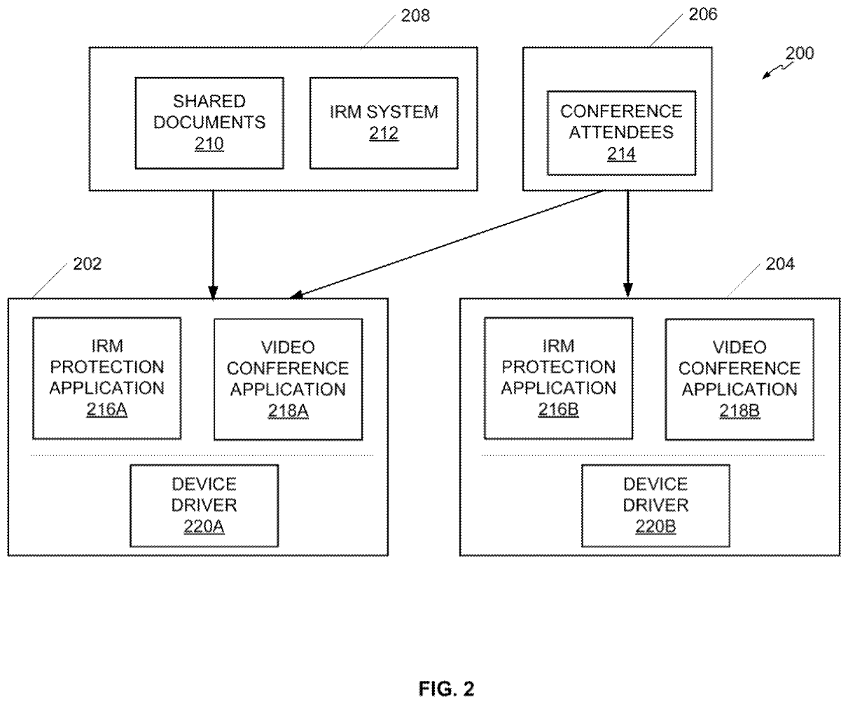

FIG. 2 is a block diagram showing an information rights management document sharing system 200, according to an example. The IRM document sharing system may include a presentation device 202, a viewing device 204, conference registry 206 and document control system 208.

The presentation device 202 may be implemented as a device utilized by a presenter in an online conference. Often, any participant within an online conference may become a presenter, similar functionality may be applied to both the presentation device 202 and the viewing device 204. The difference between the presentation device 202 and the viewing device 204 is the functional flow of data between the other parts of the system 200. For example, when a device operates as the presentation device 202, communication from document control system 208 may occur, whereas the viewing device 204 may not need to communicate with the document control system 208. During an online conference, the physical device operating as a viewing device 204 may switch to a presentation device 202. In that instance the logical communication relationships for a presentation device 202 may be established. In this example, the physical device (e.g. previously a viewing device) may change to allow for communication to another part of the system 200 consistent with the presentation device 202.

An IRM protection application 216A may execute on the presentation device 202. The IRM protection application may monitor confidential document opening and video-conferencing sharing. The IRM protection application 216A may include a video conferencing application plugin, a file system (operating system plugin), and screen-share application. The video conferencing application plugin may interface with a video conferencing application 218A. In one implementation, the video conferencing plugin may be crafted to interact with the video conference application 218A. In another implementation, multiple video conferencing application plugins may exist within the IRM protection application 216A to facilitate broad compatibility with a more than one video conferencing applications 218A from different vendors. The video conference application plugin may utilize an application programming interface (API) corresponding to the video conference application 218A. A file system may be utilized to provide an interface with a document management system 208. The file system may be used as a cloud synchronized file system whereby a document may be stored as in a repository of shared documents 210 in a cloud system. The file system may include an operating system plugin to seamlessly interface between the shared documents 210 implementation and locally stored documents.

Additionally, the IRM protection application 216A may include a screen-share application. The screen-share application interfaces both the conference registry 206, the document management system 208 and the device driver 220A. The screen-share application operates as the conduit between the multiple external components. The screen-share application my retrieve the information rights management data (or meta-data) from the IRM management system 212 of the document management system 208. The screen share application may also retrieve a set of online conference attendees from the conference registry 206. The screen share application may compare the information rights management data to the set of online conference attendees to identify all participants acceptable to view a shared online document. In another implementation, the screen share application may compare the information rights management data to the set of online conference attended to identify participants not acceptable to view a shared online document.

The video conference application 218A may correspond to a third-party application utilized to host online conferences. The video conference application 218A may have functionality to transmit video and/or audio from the presentation device 202. Likewise, the video conference application 218B on the viewer device 204 may have functionality to receive video and/or audio from the presentation device 202. The video conference application 218A, 218B may allow the presenter on the presentation device 202 to share a document for viewing on the viewer device 204. The video conference application 218A may include a plugin API to augment functionality of the video conference application. The IRM protection application 216A may interface with the video conference application 218A utilizing the plugin API.

A device driver 220A may provide the functionality for blocking or allowing the sharing of documents during an online conference. The device driver 220A on the presentation device 202 may operate at a lower application level to augment the display of a shared document during an online conference. The display driver 220A may have a communication interface through an API to the IRM protection application 216. The IRM protection application 216 may signal the device driver 220A to block or share a visual representation of the shared document. The device driver 220A may obfuscate the visual representation of the shared document based on signaling or messaging from the IRM protection application 216 by adjusting the pixels corresponding to the visual representation of the shared document. In one implementation the device driver 220A may interlace noise pixels within the viewable area of the shared document. In one implementation, the device driver 220A may operate in a kernel mode environment. By operating in kernel mode, the device driver 220A may more robustly secure the shared document from the video conference application 218A which may be executing in a user mode environment.

The device driver 220A may operate by display driver painting, display driver layering, or utilizing a virtual monitor. Display driver painting may utilize a hook when an application is created thereby allowing the device driver 220A to paint the screen corresponding to the application being used to view the shared IRM document. In another implementation, display driver layering may create a hardware overlay layer on the application being used to view the shared IRM document. In another implementation, a virtual monitor may be utilized where the device driver 220A creates a virtualized monitor instance corresponding to the application being used to view the shared IRM document, and then obfuscating the virtual monitor.

As mentioned previously a viewer device 204 may correspond to a device utilized by a participant in an online conference. The viewer device 204 may execute many of the same components as the presentation device 202, however the components may operate in a different manner. For example, the viewer device 204 may execute an IRM protection application 216B, similar to the IRM protection application 216A of the presentation device 202. The IRM protection application 216B may provide limited functionality including handshaking (not shown) with the IRM protection application 216A. Likewise, the viewer device 204 may incorporate a video conference application 2186 to receive any transmitted audio and/or video from the presentation device 202. The viewer device 204 may also include the device driver 220B. The device driver 220B may quietly execute no-ops or handshake with the IRM protection application 216B, until a participant wishes to change from a viewer role into a presenter role.

A conference registry 206 may contain one or more databases of conference attendees 214. The conference registry 206 may organize a plurality of online conferences. Each online conference may have a database of conference attendees 214. The conference attendees 214 may be identified utilizing a unique identifier. In one implementation, each of the conference attendees 214 may be identified with an email address. The conference registry 206 supports the IRM protection application 216A by providing an API to allow for the querying of any number of conference attendees 214 corresponding to a single online conference. In another implementation the conference registry may be accessed by a third-party plugin. The IRM protection application 216A may provide a query to the conference registry 206, and receive a list of the conference attendees 214. The IRM protection application 216A may validate the conference attendees 214 against the document control system 208.

The document control system 208 may include both the shared documents 210 and an information rights management (IRM) system 212. The shared documents 210 may be a common location for documents to be placed to be shared during online conference. Cloud storage may be an example of a location of placed shared documents 210. Other repositories that include documents shares accessible during an online conference may be included. For example, network attached storage may be used for the storage of shared documents 210. The shared documents may include any digital files that convey information when displayed. For example, word processing documents, presentation slides, spreadsheets, and images may be shared documents 210. Shared documents 210 may also be referred to as IRM documents, as each of the documents are tied to the IRM system 212.

An IRM system 212 may be utilized to determine who can view the shared documents. The IRM management system 212 may include meta data associated with each of the shared documents 210 describing content, groups, and users who may access the documents. The IRM system 212 may identify users utilizing the same unique identifier associated with the conference attendees 214. When a presenter requests to share a document during an online conference, the IRM protection application 216A compares a received list of conference attendees 214 against applicable users for the document in the IRM system 212. Upon determining all participants or attendees are users who may view the shared document, the IRM protection application allows the document share to take place via the video conference application 218A. Upon determining one of the participants or attendees are not users who may view the shared document, the IRM protection application signals the device driver 220A to obscure the shared document.

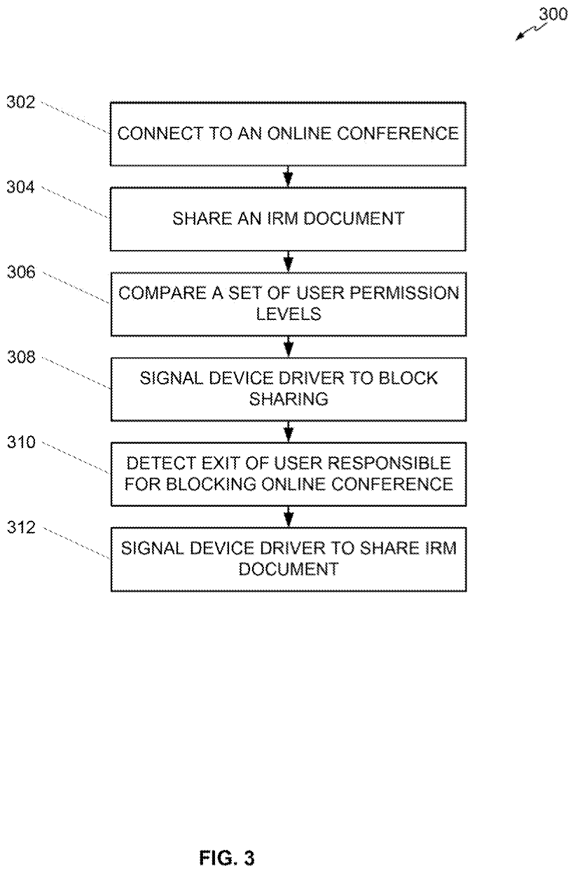

FIG. 3 is a flow diagram sharing a document based on an information rights management system, according to an example. For purposes of illustration, references to FIG. 1 and FIG. 2 may be utilized to describe components and features for implementing the functionality described in reference to FIG. 3.

At 302, the processor 102 connects to an online conference. In one implementation, a video conferencing application 218A operating on a presentation device 202 may host an online conference. The online conference may be a virtualized conference where the presentation device 202 may not organize or transmit video and/or audio to all participants, but a third party system associated with the video conference application 218A may provide infrastructure support for the transmission and reception of video and/or audio.

At 304, the processor 102 shares an information rights management (IRM) document during the online conference. In one implementation, the presentation device 202, at the presenter's behest, requests a document be shared from the shared documents 210.

At 306, the processor 102 compares each of a set of user permission levels in an IRM system to a permission level required to view the IRM document. As described above, the processor 102 may validate each of a set of users or participants in the conference against a conference registry. The IRM protection application 216A may query a list of conference attendees 214 from the conference registry 214. The processor 102 compares each of the conference attendees 214 against an entry in the IRM system 212 corresponding to the shared or IRM document 210.

At 308, the processor 102 responsive to comparison failure, signals a device driver to block sharing of the IRM document within the online conference. Upon the failing to match a participant from the conference attendees 214 in the IRM system 212 corresponding to the shared document, the processor 102 through the IRM protection application 216A, may signal the device driver.

Upon receiving a signal from the processor 102 via the IRM protection application 216A, the device driver 220A obfuscates a visualization of the IRM document to block sharing of the IRM document. The device driver 220A may present white noise painting, where the shared document may be presented as a plain black or white background. The device driver 220A may paint an error message over the visualization of the IRM document, whereby the error indicates that the document may not be shared. In another implementation, the obfuscation may include rendering a subset of the pixels required to display a visualization of the IRM document.

At 310, the processor 102 detects an exit of users responsible for comparison failure from the online conference. The IRM protection application 216A may periodically interface with the video conference application 218A during the online conference. The IRM protection application 216A may monitor a presence of each participant in the online conference by keeping a list of the last queried conference attendees 214. The IRM protection application 216A may periodically query for a new list of conference attendees 214 and compare it to the previous list of conference attendees. Upon a change in presence, or a difference in the previous list and the new list of conference attendees, revalidate each participant in the online conference against an IRM system corresponding to the IRM document.

At 312, the processor 102 signals the device driver to share the IRM document. Upon successful validation of the users or participants in the new list of conference attendees 214, the IRM protection application 216A via the processor 102 may signal the device driver 220A to render the shared document without obfuscation. Upon receipt of the signal from the processor 102 at the IRM protection applications 216A direction, the device driver 220A renders the entirety of the IRM document to share the IRM document.

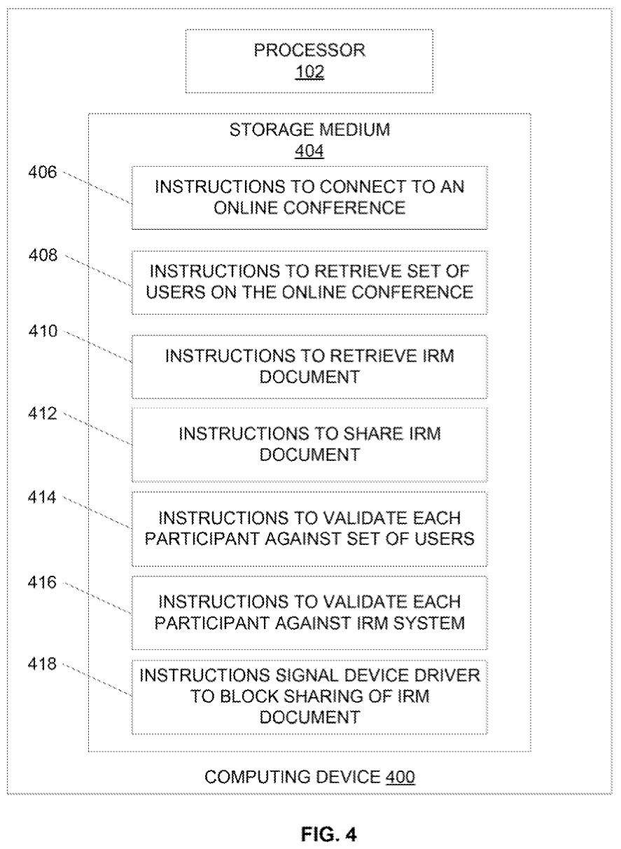

FIG. 4 is a computing device for supporting instructions for an information rights management system, according to an example. The computing device 400 depicts a processor 102 and a storage medium 404 and, as an example of the computing device 400 performing its operations, the storage medium 404 may include instructions 406-418 that are executable by the processor 102. The processor 102 may be synonymous with the processor 102 referenced in FIG. 1. Additionally, the processor 102 may include but is not limited to central processing units (CPUs). The storage medium 404 can be said to store program instructions that, when executed by processor 102, implement the components of the computing device 400.

The executable program instructions stored in the storage medium 404 include, as an example, instructions to connect an online conference 406, instructions to retrieve a set of users participating in the online conference via a third-party plugin 408, instructions to retrieve an information rights management (IRM) document 410, instructions to share the IRM document on the online conference 412, instructions to validate each participant in the online conference against the retrieved set of users 414, instructions to validate each participant in the online conference against an IRM system corresponding to the IRM document 416, and responsive to validation failure, signal a device driver to block sharing of the IRM document within the online conference 418.

Storage medium 404 represents generally any number of memory components capable of storing instructions that can be executed by processor 102. Storage medium 404 is non-transitory in the sense that it does not encompass a transitory signal but instead is made up of at least one memory component configured to store the relevant instructions. As a result, the storage medium 404 may be a non-transitory computer-readable storage medium. Storage medium 404 may be implemented in a single device or distributed across devices. Likewise, processor 102 represents any number of processors capable of executing instructions stored by storage medium 404. Processor 102 may be integrated in a single device or distributed across devices. Further, storage medium 404 may be fully or partially integrated in the same device as processor 102, or it may be separate but accessible to that computing device 400 and the processor 102.

In one example, the program instructions 406-418 may be part of an installation package that, when installed, can be executed by processor 102 to implement the components of the computing device 400. In this case, storage medium 404 may be a portable medium such as a CD, DVD, or flash drive, or a memory maintained by a server from which the installation package can be downloaded and installed. In another example, the program instructions may be part of an application or applications already installed. Here, storage medium 404 can include integrated memory such as a hard drive, solid state drive, or the like.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A system comprising:
A processor;
A memory, communicatively coupled to the processor, wherein the memory stores instructions that when executed by the processor cause the processor to:
connect an online conference;
receive an information rights management (IRM) document;
validate each of a set of users against an IRM system corresponding to the IRM document; and
responsive to validation failure, signal a device driver to block sharing of the IRM document within the online conference.

2. The system of claim 1, wherein the device driver obfuscates a visualization of the IRM document.

3. The system of claim 1, further comprising instructions to validate each of a set of users in the conference against a conference registry.

4. The system of claim 1, wherein the IRM document is opened for display in a corresponding viewer.

5. The system of claim 4, further comprising instructions to attempt to share the IRM document in the online conference.

6. A method to:
connecting to an online conference;
sharing an information rights management (IRM) document during the online conference;
comparing each of a set of user permission levels in an IRM system to a permission level required to view the IRM document.
responsive to comparison failure, signaling a device driver to block sharing of the IRM document within the online conference;
detecting an exit of users responsible for comparison failure from the online conference; and
signaling the device driver to share the IRM document.

7. The method of claim 6, wherein the device driver obfuscates a visualization of the IRM document to block sharing of the IRM document.

8. The method of claim 6, further comprising validating each of a set of users in the conference against a conference registry.

9. The method of claim 8, wherein the conference registry is accessed via a third-party plugin.

10. The method of claim 6, wherein the device driver renders the entirety of the IRM document to share the IRM document.

11. A non-transitory computer readable medium comprising instructions executable by processor to:
connect an online conference;
retrieve a set of users participating in the online conference via a third-party plugin;
retrieve an information rights management (IRM) document;
share the IRM document on the online conference;
validate each participant in the online conference against the retrieved set of users;
validate each participant in the online conference against an IRM system corresponding to the IRM document; and
responsive to validation failure, signal a device driver to block sharing of the IRM document within the online conference.

12. The medium of claim 11, wherein the device driver blanks over a visualization of the IRM document to block sharing of the IRM document.

13. The medium of claim 11, further comprising instructions to:
monitor a presence of each participant in the online conference;
upon a change in presence, revalidate each participant in the online conference against an IRM system corresponding to the IRM document; and
responsive to validation, signal the device driver to share the IRM document within the online conference.

14. The medium of claim 13 wherein the device driver renders the entirety of the IRM document to share the IRM document.

15. The medium of claim 11 wherein the online conference is presented in a third-party conferencing application.
